(19) United States
(12) Patent Application Publication
(10) Pub. No.: US 2022/0193886 A1
(43) Pub. Date: Jun. 23, 2022

(54) LOWER LIMB OF AN EXOSKELETON

(71) Applicant: COMMISSARIAT A L'ENERGIE ATOMIQUE ET AUX ENERGIES ALTERNATIVES, PARIS (FR)

(72) Inventor: Philippe GARREC, GIF-SUR- YVETTE (FR)

(73) Assignee: COMMISSARIAT A L'ENERGIE ATOMIQUE ET AUX ENERGIES ALTERNATIVES, PARIS (FR)

(21) Appl. No.: 17/595,401

(22) PCT Filed: May 26, 2020
(86) PCT No.: PCT/EP2020/064541

§ 371 Date: Nov. 16, 2021

(30) Foreign Application Priority Data
May 27, 2019 (FR) FR1905603

(51) Int. Cl. B25J 9/00; A61H 3/00

(52) U.S. Cl. CPC B25J 9/0006; A61H 3/00

(57) ABSTRACT

A lower member (1) of an ambulatory exoskeleton (2), the lower member having at least a body segment (10) having at least one first leg segment (20) hinged thereto (Ps). The lower member (1) of the exoskeleton (2) including a first hinge blocker having a first element (51) provided with functionally connecting it to turn with the first leg segment (20); a first skid (30); and a first actuator (33) capable of acting selectively to adopt a free first state in which the first element (51) is free to turn both in a first direction (S₁) and in a second direction opposite to the first direction, and a blocking second state in which turning of the first element (51) in the first direction is blocked by the first element (51) jamming against the first skid (30).

### FIELD OF THE INVENTION

The invention relates to the field of exoskeletons, and more particularly to lower members of ambulatory exoskeletons.

### BACKGROUND OF THE INVENTION

Conventionally, an ambulatory exoskeleton lower member comprises a body segment hinged to a first end of a leg segment and a foot segment hinged via of an ankle to a second end of the leg segment. The exoskeleton also has means for connecting it to a user. In general, adduction/abduction movement relative to the body segment (i.e. movement parallel to the sagittal plane) is left free. Human walking is essentially a succession of unstable stages of unipedal support interspersed with very short stages of bipedal support. The unstable state is characterized by the fact that the user's center of gravity is not situated vertically above the supporting foot. The resulting tilting moment gives rise to an accelerated movement referred to as an inverted pendulum. Walking motion is thus a series of tilting movements (taking place both in the sagittal plane and in the frontal plane) that are separated by transitions between bipedal support and unipedal support.

When the user of the exoskeleton passes from being stationary (stable bipedal posture) to walking, the tilting moment is even stronger because the user's legs are further apart than they become once a regular walking is established (humans tend to move their legs closer together in the frontal plane while walking).

During stages of tilting, and also in order to anticipate the bipedal to unipedal transition, the user stiffens the body, which then tends to tilt about an ankle or else about an edge defining the end of a foot (or of a sole).

For an exoskeleton having its abduction/adduction axis left free, the tilting moment produces angular acceleration about this axis of the body (pelvis/back) segment together with everything it is carrying, e.g. such as a payload. This movement is stopped by user reactions, which are transmitted via the means connecting the user to the exoskeleton, and these reactions amount to rough jolting. Such a situation is uncomfortable for the user, and it creates a sensation of insecurity that is hindering the development of ambulatory exoskeletons.

### OBJECT OF THE INVENTION

An object of the invention is to improve the comfort of the user of an ambulatory exoskeleton when passing from a bipedal situation to a unipedal situation.

### SUMMARY OF THE INVENTION

To this end, the invention provides a lower member of an ambulatory exoskeleton, the lower member comprising at least a body segment having at least one first leg segment hinged thereto about a first axis parallel to a sagittal plane, the lower member of the exoskeleton including a first hinge blocker arranged to act selectively to block turning of the first leg segment about the first axis. The first hinge blocker comprises:
a first element provided with means for functionally connecting it to turn with the first leg segment;
a first skid mounted to turn about a second axis of rotation on a first fixed point of the exoskeleton; and
a first actuator arranged to act selectively to cause the first skid to turn about the second axis of rotation;

the first actuator being capable of acting selectively to adopt a free first state in which the first element is free to turn both in a first direction and in a second direction opposite to the first direction, and a blocking second state in which turning of the first element in the first direction is blocked by the first element jamming against the first skid.

A blocking system is thus obtained that is compact and lightweight and that enables a hinge to be blocked quickly without adding any significant inertia to the leg segment.

In the meaning of the present application, the jamming is a consequence of relative movement between two parts being stopped as a result of an increase in the friction between them, with persistence in the cause of that movement giving rise to deformation that reinforces the blocking.

It is possible to actuate both legs of a user when the lower member also includes a second leg segment hinged to the body segment about a third axis parallel to the sagittal plane. The exoskeleton lower member then includes a second hinge blocker arranged to act selectively to block turning of the second leg segment about the third axis. According to the invention, the second hinge blocker comprises:
a second element provided with means for functionally connecting it to turn with the second leg segment;
a second skid mounted to turn about a fourth axis of rotation on a second fixed point of the exoskeleton; and
a second actuator arranged to act selectively to cause the second skid to turn about the fourth axis of rotation. The second actuator is capable of acting selectively to adopt a free third state in which the second element is free to turn both in a third direction and in a fourth direction opposite to the third direction, and a locking fourth state in which turning of the second element in the third direction is blocked by the second element jamming against the second skid.

A compact device is obtained when the first hinge blocker includes a first rotary actuator and/or the second hinge blocker includes a second rotary actuator. The blocking takes place particularly quickly when the first rotary actuator and/or the second rotary actuator includes an electromagnet.

Advantageously, the first element comprises a first cylindrical sector and/or the second element comprises a third cylindrical sector and/or the first skid comprises a second cylindrical sector and/or the second skid comprises a fourth cylindrical sector.

A compact lower member is obtained when the first axis and the second axis are parallel and/or the third axis and the fourth axis are parallel.

The reliability of the device is improved when the lower member is arranged so that when the first actuator is in its blocking second state, the first element is allowed to turn in the second direction and/or when the second actuator is in its blocking fourth state, the second element is allowed to turn in the fourth direction.

The effectiveness of the blocking is improved when the first element and/or the first skid and/or the second element and/or the second skid include(s) a friction pad.

Other characteristics and advantages of the invention appear on reading the following description of a particular, nonlimiting embodiments of the invention.

### BRIEF DESCRIPTION OF THE DRAWINGS

Reference is made to the accompanying figures, in which:

FIG. 1 is a diagrammatic perspective view of a user wearing an exoskeleton in a first embodiment of the invention;

FIG. 2 is a diagrammatic front view of the FIG. 1 exoskeleton;

FIG. 3 is a fragmentary detail view of the FIG. 1 exoskeleton in a blocking second state;

FIG. 4 is a diagrammatic view of an exoskeleton in a second embodiment of the invention;

FIG. 5 is a diagrammatic front view of the FIG. 4 exoskeleton; and

FIG. 6 is a fragmentary detail view of the FIG. 4 exoskeleton in a blocking second state.

### DETAILED DESCRIPTION OF THE INVENTION

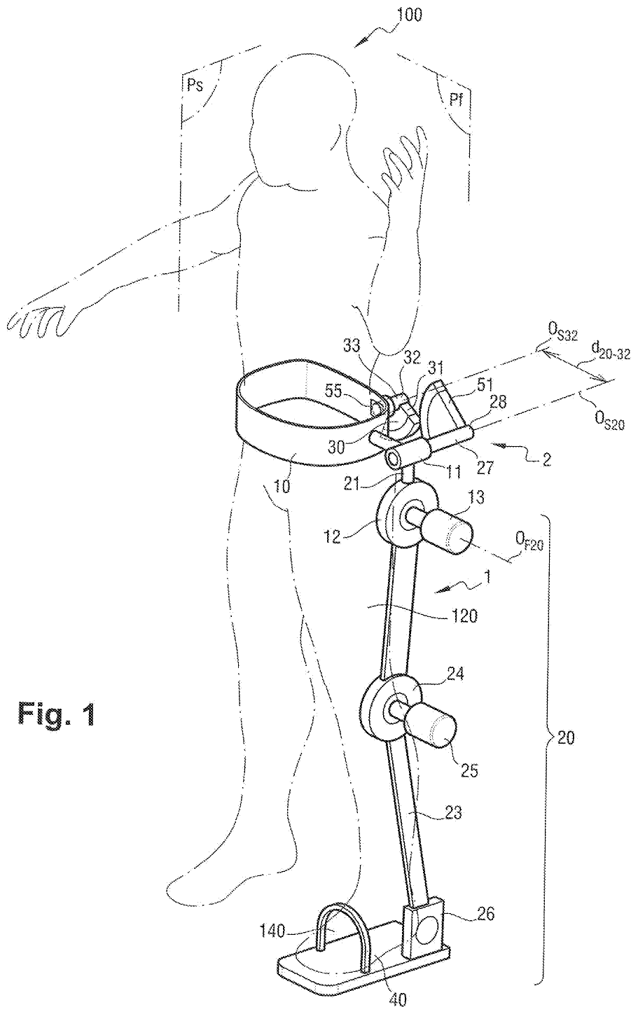

With reference to FIGS. 1 to 3, the lower member, given overall reference 1, of an ambulatory exoskeleton 2 is worn by a user 100. The lower member 1 comprises a body segment 10 and a left first leg segment 20. A first end 21 of the first leg segment 20 is freely hinged about a first abduction/adduction axis Oₛ₂₀ parallel to a sagittal plane Ps via a first hinge 11, specifically a bronze bearing.

The first leg segment 20 is also hinged to the body segment 10 about an axis O_{f20} lying in a frontal plane Pf via a second hinge 12 actuated by a first gearmotor 13. The first leg segment 20 comprises a first thigh segment 22 hinged to a first tibia segment 23 by a third hinge 24 actuated by a second gearmotor 25. At a second end 26 of the first leg segment 20, a left foot segment 40 is freely hinged to the first tibia segment 23. The body segment 10 and the left foot segment 40 are connected respectively to the body 110 and to the left foot 140 of the user 100 by means of straps. Optionally, the first thigh segment 22 and the first tibia segment 23 may be connected respectively to the thigh 121 and to the tibia 122 of the leg 120 of the user 100 by straps.

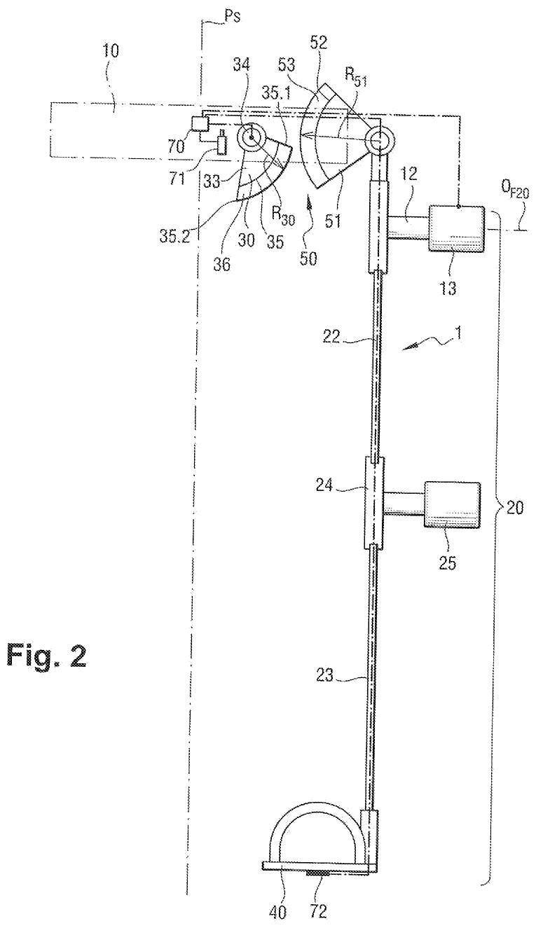

As can be seen in FIG. 2, the first leg segment 20 includes a first shaft 27 that is constrained to turn with the first thigh segment 22 and that extends along the first axis Os20. The first gearmotor 13 and the second gearmotor 25 are connected to a monitor and control unit 70 that is carried by the body segment 10 that also carries a battery 71. The exoskeleton 2 also has a pressure sensor 72 situated in the left foot segment 40 and capable at least of detecting pressure against the ground. The sensor 72 is also connected to the control unit 70.

The lower member 1 of the ambulatory exoskeleton 2 also has a first hinge blocker 50 mounted on the body segment 10. The first hinge blocker 50 comprises a first element 51 secured to a rear end 28 of the first shaft 27. In this example, the first element 51 is a steel cylindrical sector having a first radius R₅₁ and having its outside surface 52 covered by a first ceramic friction pad 53.

The first hinge blocker 50 also comprises a first skid 30 secured to the end 31 of a second shaft 32 that is the output shaft of a first rotary actuator 33 comprising a first electromagnet 34. The first actuator 33 is bolted onto a first plate 54 of the body segment 10. The second output shaft 32 extends along a second axis of rotation Oₛ₃₂ parallel to the first axis Oₛ₂₀ and spaced apart therefrom by a distance d20-32. The outside surface 35 of the first skid 30 is covered by a second ceramic friction pad 36. In this example, the first skid 30 is a steel eccentric having a varying second radius R₃₀. The radius R30 increases linearly between the first end 35.1 and the second end 35.2 of the outside surface 35 of the first skid 30.

In advantageous but non essential manner, the first element 51 and the first skid 30 extend substantially in the same plane that is parallel to the frontal plane Pf. The terminals of the first electromagnet 34 are connected to the control unit 70.

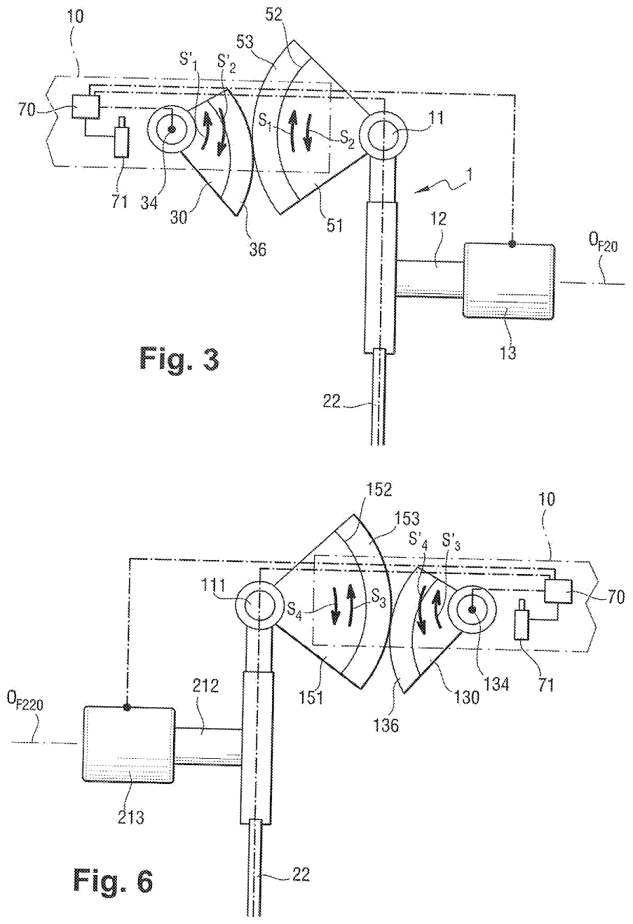

In the absence of a control voltage being applied by the unit 70 to the terminals of the first electromagnet 34, the first actuator 33 is in a free first state in which the second friction pad 36 of the first skid 30 is not in contact with the first pad 53 of the first element 51 and the first element 51 is free to turn in a first direction S₁ (in this example, in a clockwise direction as shown in FIGS. 2 and 3) and also in a second direction S₂ opposite to S₁. When the unit 70 applies a control voltage the terminals of the first electromagnet 34, the second output shaft 32 turns through about 45° (in the counterclockwise direction S₁′ as shown in FIGS. 2 and 3) so as to bring the second pad 36 of the first skid 30 into contact with the first pad of the first element 51. The first actuator 33 is then in a blocking second state (FIG. 3). In this blocking second state, while the first element 51 is turning in the first direction S₁, the friction between the first pad 53 of the first element 51 and the second pad 36 of the first skid 30 causes the first skid 30 to turn in the direction S′₁. Since the second radius R30 is increasing, the thrust pressure of the first skid 30 of the first element 51 increases with the turning movement of the first element 51 in the first direction S₁, thereby braking the turning of the first element in the first direction S₁. This braking leads quickly, or even instantaneously, to the turning of the first element 51 in the first direction of rotation S₁ becoming blocked by jamming.

In operation, when the user 100 seeks to walk, the user stands on the right foot while lifting the left foot 140, thereby activating the sensor 72, which transmits a measurement to the unit 70. The unit 70 then detects that the user 100 intends to leave the bipedal stage in order to walk, and it causes a voltage to be applied to the terminals of the first electromagnet 34 so that it passes from its free first state (FIG. 2) to its blocking second state (FIG. 3). The first skid 30 comes into contact with the first element 51 and blocks turning of the first element 51 in the first direction of rotation S₁. The effect of locking turning of the first element 51 is to block turning of the first hinge 11 of the first leg segment 20 about the abduction/abduction axis in the abduction direction (the body segment 10 turning downwards relative to the lower member 1).

A lower member 1 of the exoskeleton 2 is thus obtained in which turning of a leg segment 20 about its abduction/abduction axis can be blocked and unblocked dynamically and quickly, regardless of the position of the leg segment 20. Thus, the body segment 10 of the exoskeleton 2 and the leg segment 20 are stiffened in the frontal plane Pf. The moment induced by the weight of the exoskeleton 2 on passing from a bipedal situation to a unipedal situation leads to the exoskeleton 2 as a whole tilting about the hinge of the foot 40, like the movement followed by the user 100. This thus reduces the jolting transmitted to the user by the connections with the exoskeleton 2.

Advantageously, the first actuator 33 is selected in such a manner that its opposing torque (i.e. opposing any return of the skid 30 from its blocking second position to its free first position) is low (about 10% or less) compared with the torque applied by the user 100 via the first leg segment 20 on the first element 51. Thus, turning the first element 51 in a second direction of rotation S2 opposite to the first direction of rotation S₁ causes the first skid 30 to turn in a direction S′₂ (specifically counterclockwise as shown in FIGS. 2 and 3) thereby reducing the thrust pressure from the first skid 30 on the first element 51 and thus allowing the first element 51 to turn in the second direction S₂.

In the following description of a second embodiment of the invention, elements that are identical or analogous to those described above are given identical numerical references.

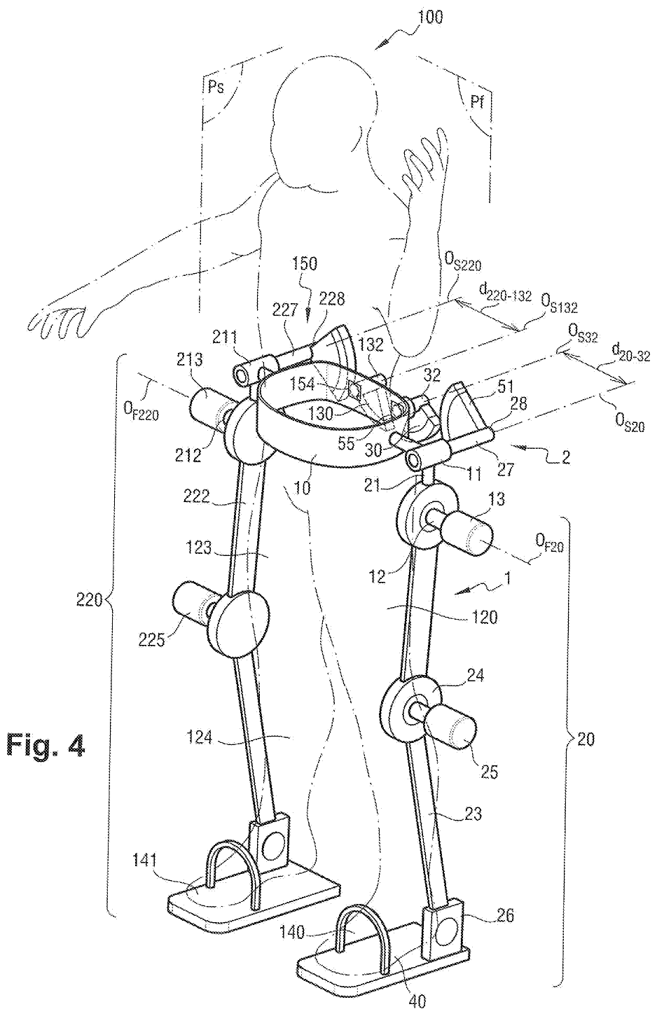

In a second embodiment and with reference to FIGS. 4 to 6, the exoskeleton 2 has a right second leg segment 220 that is similar to the first leg segment 20 and that is hinged to the body segment 10 about a third abduction/abduction axis Oₛ₂₂₀ parallel to the sagittal plane Ps via a fourth hinge 211, specifically a bronze bearing.

The second leg segment 220 is also hinged to the body segment 10 about an axis O_{f220} lying in a frontal plane Pf via a fourth hinge 211 actuated by a third gearmotor 213. The second leg segment 220 comprises a second thigh segment 222 hinged to a second tibia segment 223 by a fifth hinge 224 that is actuated by a fourth gearmotor 225. At a second end 226 of the second leg segment 220, a right foot segment 240 is freely hinged to the second tibia segment 223. The right foot segment 240 is connected to the right foot 141 of the user 100 by straps. Optionally, the second thigh segment 222 and the second tibia segment 223 may be connected respectively to the thigh 123 and to the tibia 124 of the leg 120 of the user 100 by straps.

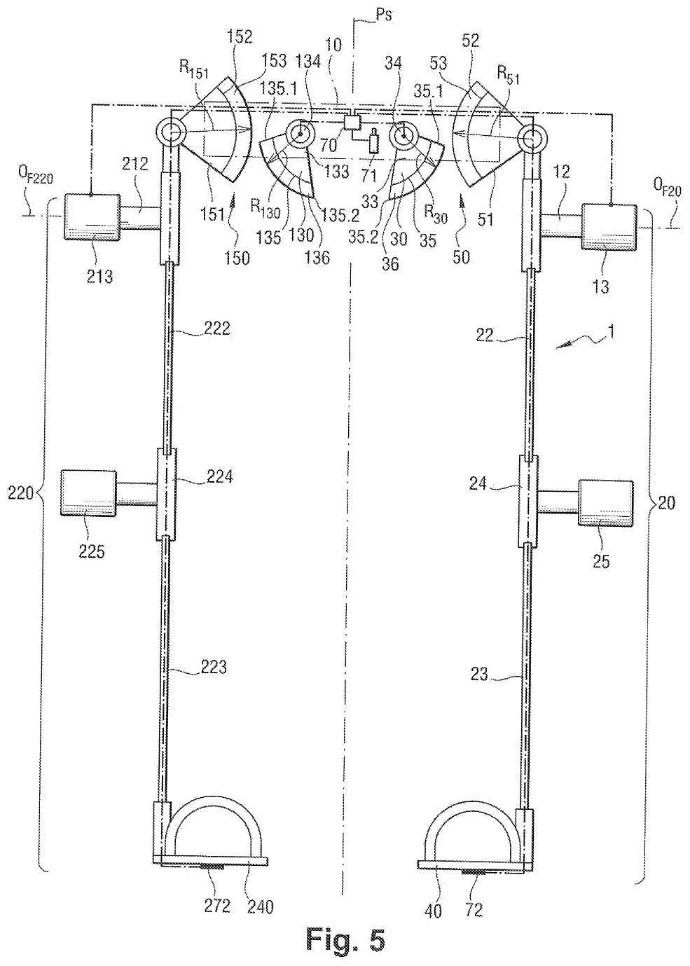

As can be seen in FIGS. 4 and 5, the second leg segment 220 includes a third shaft 227 that is constrained to turn with the second thigh segment 222 and that extends along the axis Os220. The third gearmotor 213 and the fourth gearmotor 225 are connected to the monitor and control unit 70.

A second pressure sensor 272 is situated under the foot segment 240 of the second leg segment 220.

The lower member 1 of the ambulatory exoskeleton 2 also has a second hinge blocker 150 mounted on the body segment 10. In corresponding manner to the first hinge blocker 50, the second hinge blocker 150 comprises a second element 151 secured to a rear end 228 of the third shaft 227. In this example, the second element 151 is a steel cylindrical sector having a first radius R₁₅₁ and having its outside surface 152 covered by a third ceramic friction pad 153.

The second hinge blocker 150 also comprises a second skid 130 secured to the end 131 of a fourth shaft 132 that is the output shaft of a first rotary actuator 33 comprising a second electromagnet 134. The second actuator 133 is bolted onto a second plate 154 of the body segment 10. The fourth output shaft 132 extends along a fourth axis of rotation O_{S132} parallel to the third axis Oₛ₂₂₀ and spaced apart therefrom by a distance d₂₂₀₋₁₃₂. The outside surface 135 of the second skid 130 is covered by a fourth ceramic friction pad 136. In this example, the second skid 130 is a steel eccentric having a varying second radius R₁₃₀. The radius R₁₃₀ increases linearly between the first end 135.1 and the second end 135.2 of the outside surface 135 of the second skid 130.

In advantageous but non essential manner, the second element 151 and the second skid 130 extend substantially in the same plane that is parallel to the frontal plane Pf. The terminals of the second electromagnet 134 are connected to the control unit 70.

In the absence of a control voltage being applied by the unit 70 to the terminals of the second electromagnet 134, the second actuator 133 is in a free first state in which the fourth friction pad 136 of the second skid 130 is not in contact with the third pad 153 of the second element 151 (FIGS. 4 and 5) and the second element 151 is free to turn in a third direction S₃ (in this example, in a counterclockwise direction as shown in FIGS. 5 and 6) and also in a fourth direction S₄ opposite to S₃. When the unit 70 applies a control voltage the terminals of the second electromagnet 134, the fourth output shaft 132 turns through about 45° (in the clockwise direction S₃′ as shown in FIGS. 5 and 6) so as to bring the fourth pad 136 of the second skid 130 into contact with the third pad 153 of the second element 151. The second actuator 133 is then in a blocking second state (FIG. 6). In this blocking second state, during turning of the second element 151 in a third direction S₃ (specifically in the counterclockwise direction as shown in FIGS. 5 and 6), the friction between the third pad 153 of the second element 151 and the fourth pad 136 of the second skid 130 causes the second skid 130 to turn in a direction S′3 (specifically a clockwise direction as shown in FIGS. 5 and 6). Since the second radius R130 is increasing, the thrust pressure of the second skid 130 on the second element 151 increases with the turning movement of the second element 151 in the third direction S₃, thereby braking the turning of the second element in the third direction S₃. This braking leads quickly, or even instantaneously, to the turning of the second element 151 in the third direction of rotation S₃ becoming blocked by jamming.

The second hinge blocker 150 operates in a manner identical to that described for the first hinge blocker 50.

Naturally, the invention is not limited to the embodiments described, but covers any variant coming within the ambit of the invention as defined by the claims.

In particular:
although above, the first abduction/adduction hinge and the second hinge of the first leg segment are both about respective axes lying either in the frontal plane or else in the same plane parallel to the sagittal plane, the invention applies equally to other relative configurations of these hinges, e.g. such as a first abduction/adduction hinge situated closer to the sagittal plane than the second hinge of the first leg segment, or indeed situated in the sagittal plane. Such a configuration is better at accompanying the natural movements of the human body;
although above, the first hinge is a bronze bearing, the invention applies equally to other types of hinge, e.g. such as ball joints, roller bearings, needle bearings, ball bearings, or magnetic bearings;
although above, the first element is secured to the rear of the first shaft, the invention applies equally to other means for functionally constraining the first leg segment to turn with the first element, e.g. such as a first element secured to a middle or front portion of a shaft that is itself constrained to turn together with the first leg segment, a gear train that optionally reduces movement and that has at least one gear secured to the first element or connected to the leg segment;
although above, the first or second element is a steel cylindrical sector of constant radius, the invention applies equally to other types of first or second element, e.g. such as a complete wheel, an eccentric, or any other optionally curved shape, which may optionally be closed. The first or second element may be made of other materials, e.g. such as a material that is synthetic or nonferrous;
although above, the first or second skid is a steel cylindrical sector of linearly varying radius, the invention applies equally to other types of first or second skid, e.g. such as a complete wheel, an eccentric, or any other optionally curved shape, which may optionally be closed, and of radius that may be constant or that may vary in non-linear manner. The first or second skid may be made of other materials, e.g. such as a material that is synthetic or nonferrous;
although above, the first actuator is connected by bolts to the body segment, the invention applies equally to other types of connection to a fixed point of the exoskeleton, e.g. such as adhesive, riveting, or screw fastening;
although above, the shaft of the actuator extends along an axis that is parallel to the axis of rotation of the first element, the invention applies equally to other relative orientations of the axes, e.g. such as a first actuator shaft that is orthogonal to the axis of rotation of the first element;
although above, the friction pads of the first and second elements and the first and second skids are made of ceramic, the invention applies equally to elements and/or skids that do not have friction pads (steel on steel braking) or that are provided with pads of other types that may comprise carbon or poly(p-phenylene teraphthalamide);
although above, the lower member of the exoskeleton includes one or two hinge blockers, the invention applies equally to a lower member including more than two hinge blockers, e.g. three or more;
although above, the shaft of the actuator turns through about 45°, the invention applies equally to rotary actuators having an outlet shaft that turns through some other amplitude that may be greater than or less than 45⁰;
although above, the first segment is freely hinged to an actuated tibia segment, the invention applies equally to other configurations for actuating different segments of the exoskeleton, e.g. such as a foot segment that is actuated by the tibia segment or a tibia segment that is freely hinged to the thigh segment;
although above, the exoskeleton includes batteries, the invention applies equally to other exoskeleton power supply means, e.g. such as electrical power by wire, pneumatic power, or hydraulic power;
although above, the exoskeleton includes a pressure sensor situated under the foot segment of the exoskeleton, the invention applies equally to other means for detecting the attitude of the exoskeleton or detecting the exoskeleton passing from a bipedal situation to a unipedal situation, e.g. such as an inertial unit situated in the body segment, a contactor placed under the foot segment of the exoskeleton, or under the user's foot, gyros, or myoelectrical sensors;
although above, the hinge blocker is mounted on the body segment, the invention applies equally to the hinge blocker having some other location in the exoskeleton, e.g. such as a hinge blocker connected to a dorsal portion of the exoskeleton;
although above, the first output shaft of the first actuator is mounted to turn about an axis parallel to the sagittal plane, the invention applies equally to the axis of rotation of the drum having some other orientation;
although above, the first and the second actuators are electromagnetic rotary actuators, the invention applies equally to other types of actuator, e.g. such as linear actuators of the pneumatic cylinder type, of the rack-and-pinion type, or a rotary pneumatic actuator;
although above, the leg segment comprises a tibia segment actuated on a thigh segment, the invention applies equally to other actuation configurations, e.g. such as a leg segment not having any actuator;
although above, the lower member comprises a body segment connected to the user's body and having leg segments in thereto, the invention applies equally to other types of body segment, e.g. suitable for being connected to the user's pelvis or back;
although above, the first end of the left first leg segment is hinged to the body segment by a ball joint, the invention applies equally to other types of hinge, such as a three-axis connection arranged in dynamically equivalent manner; and
although above, the first element is mounted to turn about an axis parallel to the first axis, the invention applies equally to other orientations for the axis of rotation of the first element, e.g. such as a first element connected to the first leg segment by means of an angle gear.

1. A lower member of an ambulatory exoskeleton, the lower member comprising at least a body segment having at least one first leg segment hinged thereto about a first axis parallel to a sagittal plane, the lower member of the exoskeleton including a first hinge blocker arranged to act selectively to block turning of the first leg segment about the first axis the first hinge blocker comprising:
a first element provided with means for functionally connecting it to turn with the first leg segment;
a first skid mounted to turn about a second axis of rotation on a first fixed point of the exoskeleton; and
a first actuator arranged to act selectively to cause the first skid to turn about the second axis of rotation;
the first actuator being capable of acting selectively to adopt a free first state in which the first element is free to turn both in a first direction and in a second direction opposite to the first direction, and a blocking second state in which turning of the first element in the first direction is blocked by the first element jamming against the first skid.

2. A lower member according to claim 1, including a second leg segment hinged to the body segment about a third axis parallel to the sagittal plane, the lower member of the exoskeleton including a second hinge blocker arranged to act selectively to block turning of the second leg segment about the third axis, the second hinge blocker comprising:
a second element provided with means for functionally connecting it to turn with the second leg segment;
a second skid mounted to turn about a fourth axis of rotation on a second fixed point of the exoskeleton; and
a second actuator arranged to act selectively to cause the second skid to turn about the fourth axis of rotation;
the second actuator being capable of acting selectively to adopt a free third state in which the second element is free to turn both in a third direction and in a fourth direction opposite to the third direction, and a locking fourth state in which turning of the second element in the third direction is blocked by the second element jamming against the second skid.

3. A lower member according to claim 1, wherein the first hinge blocker includes a first rotary actuator and/or the second hinge blocker includes a second rotary actuator.

4. A lower member according to claim 3, wherein the first rotary actuator and/or the second rotary actuator includes an electromagnet.

5. A lower member according to claim 1, wherein the first element comprises a first cylindrical sector and/or the second element comprises a third cylindrical sector.

6. A lower member according to claim 1, wherein the first skid comprises a second cylindrical sector and/or the second skid comprises a fourth cylindrical sector.

7. A lower member according to claim 1, wherein the first axis and the second axis are parallel and/or the third axis and the fourth axis are parallel.

8. A lower member according to claim 1, wherein when the first actuator is in its blocking second state, the first element is allowed to turn in the second direction, and/or when the second actuator is in its blocking fourth state, the second element is allowed to turn in the fourth direction.

9. A lower member according to claim 1, wherein the first element and/or the first skid and/or the second element and/or the second skid include(s) a friction pad.
